(19) United States
(12) Patent Application Publication
(10) Pub. No.: US 2007/0160215 A1
(43) Pub. Date: Jul. 12, 2007

(54) Method and medium for expanding listening sweet spot and system of enabling the method

(75) Inventors: Young Tae Kim, Seongnam-si (KR); Jung Ho Kim, Yongin-si (KR); Sang Chul Ko, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/448,094

(22) Filed: Jun. 7, 2006

(30) Foreign Application Priority Data
Jan. 10, 2006 (KR) 10-2006-0002618

(51) Int. Cl. H04R 5/00

(52) U.S. Cl. 381/1; 381/17

(57) ABSTRACT

An operation method of a binaural system and the binaural system adopting the method is provided. That is, a method to stably provide a stereo sound, creating a plurality of sound images and expanding a listening sweet spot by using a plurality of static filters or modulation filters when a user listens to an audio sound, even if a user turns his/her head to or moves, and the method adopted by the binaural system. The binaural system includes a plurality of static filters connected in parallel to each other, the plurality of static filters creates a sound image in a different location by controlling an output location of an inputted audio signal, and a control unit inputting the audio signal to the plurality of static filters.

### CROSS-REFERENCE TO RELATED APPLICATIONS

This application claims the benefit of Korean Patent Application No. 10-2006-0002618, filed on Jan. 10, 2006, in the Korean Intellectual Property Office, the disclosure of which is incorporated herein by reference.

### BACKGROUND OF THE INVENTION

1. Field of the Invention

The present invention relates to an operation method of a binaural system and the binaural system adopted by the method. More, particularly, the present invention relates to a method for stably providing a stereo sound, creating a plurality of sound images and expanding a listening sweet spot by using a plurality of static filters or a plurality of modulation filters while listening to an audio sound, even if a user turns to or moves, and the method adopted by the binaural system.

2. Description of the Related Art

Recently, various methods for providing a vivid sound have been developed for users' in step with users' improved quality of life. Particularly, a binaural system, outputting a sound by using two channels with a direction property, is utilized for providing a vivid sound.

FIG. 1 is a diagram illustrating a binaural system using a conventional technique. Referring to FIG. 1, a binaural system using a conventional technique locates two mike channels, 101 and 102, and outputs an audio signal. In this instance, a binaural system sets up a virtual location of ears 103 and outputs a stereo sound near a listening sweet spot 104. In this instance, a surround sound effect is achieved due to an audio signal, which is actually outputted from two mike channels 101 and 102, and the surround sound effect sounds as if an audio signal is being outputted from a sound image 105 to a user.

However, a listening sweet spot 104 of a binaural system using a conventional technique is narrow. Therefore, a user is provided with only a small area to enjoy a surround sound. That is, because a listening sweet spot 104 is predetermined, when a user is out of a listening sweet spot 104, a surround sound effect becomes less effective.

Namely, when a user is off a listening sweet spot 106 by moving oneself outside of listening sweet spot 104, such as nodding his/her head and the like, a location of another sound image 107 is different and a user may not experience a surround sound effect. Accordingly, a development of a new binaural system, which may solve the above problem of a conventional technique and expand a listening sweet spot area and may let a user enjoy a surround sound in an expanded area, is earnestly desired.

### SUMMARY OF THE INVENTION

Additional aspects and/or advantages of the invention will be set forth in part in the description which follows and, in part, will be apparent from the description, or may be learned by practice of the invention.

An aspect of the present invention provides an operation method of a binaural system which stably provides a stereo sound, and creates a listening sweet spot corresponding to a plurality of sound images even when a user moves at random within a certain area of a listening sweet spot, and the method adopted by the binaural system.

An aspect of the present invention also provides an operation method of a binaural system which stably provides a stereo sound, even when a user moves at random within a certain area of a listening sweet spot, by moving a sound image in a predetermined time interval and expanding a listening sweet spot, and the binaural system adopting the method.

An aspect of the present invention also provides an operation method of a binaural system which reduces a load on the system, caused by a simultaneous operation of a plurality of static filters, and expands a listening sweet spot without the simultaneous operation of the plurality of static filters, and the binaural system adopting the method.

An aspect of the present invention provides an operation method of a binaural system which expands a listening sweet spot by using a plurality of modulation filters without a plurality of static filters, and the binaural system adopting the method.

According to an aspect of the present invention, there is provided a system providing a stereo sound, the system including: a plurality of static filters connected in parallel to each other, each of the plurality of static filters creating a sound image in a different location by controlling an output location of an audio signal, and a control unit inputting the audio signal to each of the plurality of static filters.

According to another aspect of the present invention, there is provided a system providing a stereo sound, the system including: a plurality of modulation filters creating a first audio signal that creates each sound image in a different location by controlling a phase and a gain of an inputted audio signal, and a static filter creating the sound image by outputting the first audio signal.

According to still another aspect of the present invention, there is provided an operation method of a binaural system, the method including: maintaining a plurality of static filters connected in parallel to each other; inputting an audio signal to the plurality of static filters; and respectively creating a sound image in a different location by controlling an output location of the inputted audio signal from the plurality of static filters.

According to yet another aspect-of the present invention, there is provided an operation method of a binaural system providing a stereo sound, the method including: creating a plurality of first audio signals, each of the plurality of first audio signals respectively creating a sound image at a different location by controlling a phase and a gain of an inputted audio signal, and creating each of the sound image by outputting the plurality of first audio signals.

According to yet another aspect of the present invention, there is provided a binaural system including a plurality of modulation filters receiving an inputted audio signal, wherein each modulation filter creates a modulated and filtered audio signal, each modulated and filtered audio signal is used to create a sound image in a different location by controlling a phase and a gain of the inputted audio signal; and a control unit inputting the audio signal to each of the plurality of modulation filters.

Additional and/or other aspects, features, and advantages of the present invention will be set forth in part in the description which follows and, in part, will be obvious from the description, or may be learned by practice of the invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an exemplary embodiment of a binaural system using a conventional technique;

FIG. 2 is a diagram illustrating an operation process of a binaural system according to an exemplary embodiment of the present invention;

FIG. 3 is a diagram illustrating a static filter according to an exemplary embodiment of the present invention;

FIG. 4 is a diagram illustrating a plurality of sound images created from a binaural system according to an exemplary embodiment of the present invention;

FIG. 5 is a diagram illustrating an operation process of a binaural system according to another exemplary embodiment of the present invention;

FIG. 6 is a diagram illustrating a plurality of sound images created from a binaural system according to another exemplary embodiment of the present invention;

FIG. 7 is a diagram illustrating an operation process of a binaural system according to another exemplary embodiment of the present invention;

FIG. 8 is a diagram illustrating a modulation filter according to an exemplary embodiment of the present invention; and

FIG. 9 is a diagram illustrating a plurality of sound images created from a binaural system according to another exemplary embodiment of the present invention.

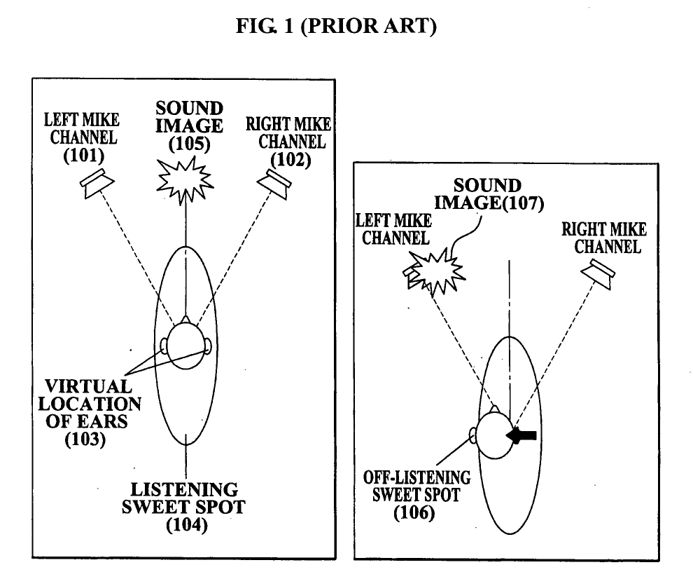

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below in order to explain the present invention by referring to the figures.

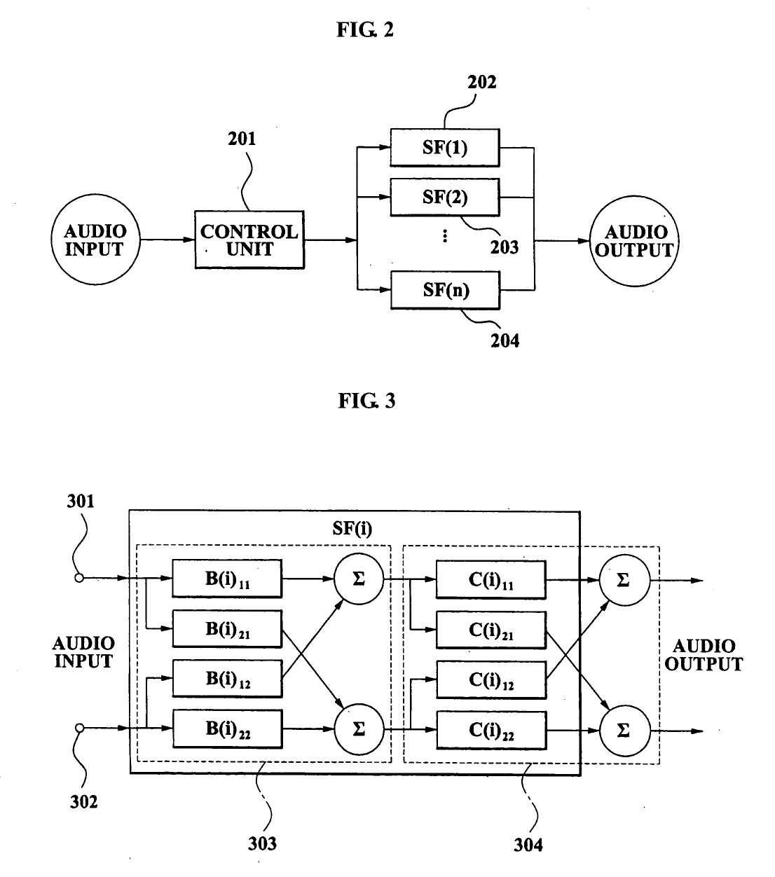

FIG. 2 is a diagram illustrating an operation process of a binaural system according to an exemplary embodiment of the present invention. Referring to FIG. 2, a binaural system according to an exemplary embodiment of the present invention includes a plurality of static filters, 202, 203 and 204, connected in parallel to each other, and a control unit 201.

When an audio signal is inputted, the control unit 201 inputs the audio signal to the plurality of static filters 202, 203, and 204. In the exemplary embodiment shown in FIG. 2, the audio signal may be simultaneously inputted to the plurality of static filters. Each of the plurality of static filters controls an output location of the inputted audio signal and creates a sound image in a different location. The number of static filters (n) may vary according to a binaural system environment.

FIG. 3 is a diagram illustrating a static filter according to an exemplary embodiment of the present invention. Referring to FIG. 3, each static filter includes a binaural synthesizer 303 and a crosstalk canceller 304.

The binaural synthesizer 303 of the static filter controls a location of an audio signal inputted via input terminals 301 and 302 and creates sound images. The crosstalk canceller 304 prevents audio sounds from being cross outputted with each other, and outputs a stereo sound.

Thus, each of the plurality of static filters creates a sound image by controlling an output location of an audio signal. Since a binaural system of an exemplary embodiment of the present invention includes the plurality of static filters, each of the plurality of sound images is created in a different location.

In an exemplary embodiment, since a location of a created sound image corresponding to a static filter is determined according to a setting of the binaural synthesizer 303, each of the sound images corresponding to each of the plurality of static filters may be spaced apart by a predetermined distance from a common axis and may be arranged in parallel by changing a setting of the binaural synthesizer 303. In this exemplary embodiment, the predetermined distance may be determined to be overlapping listening sweet spots of sound images that have been created by other static filters.

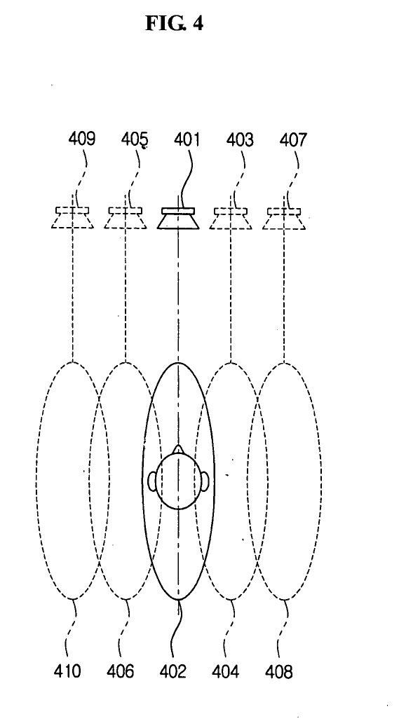

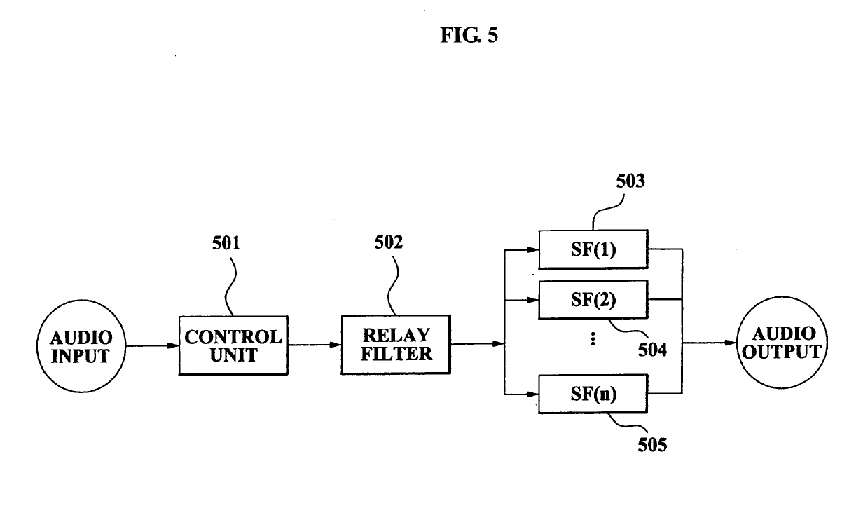

FIG. 4 is a diagram illustrating a plurality of sound images created from a binaural system according to an exemplary embodiment of the present invention. Referring to. FIG. 4, an exemplary embodiment of a binaural system of the present invention outputs a plurality of sound images, 401, 403, 405, 407 and 409, each of which is created by one of at least one static filter, respectively,

As an example, a sound image 401 in FIG. 4 may be created from a static filter SF(1) of FIG. 2, a sound image 403 in FIG. 4 may be created from a static filter SF(2) of FIG. 2, a sound image 405 in FIG. 4 may be created from a static filter SF(3) of FIG. 2, a sound image 407 in FIG. 4 may be created from a static filter SF(4) of FIG. 2 and a sound image 409 in FIG. 4 may be created from a static filter SF(5) of FIG. 2.

Accordingly, listening sweet spots, 402, 404, 406, 408 and 410, are created corresponding to each sound image, and therefore, a stereo sound may be stably provided, even if a user moves at random within an area of a plurality of listening sweet spots.

According to the above exemplary method of outputting, however, a high load on the system is required to create the sound images due to the fact that a plurality of static filters are being simultaneously operated. Thus, according to another exemplary embodiment of the present invention, a method which can expand a listening sweet spot without simultaneous operation of a plurality of static filters is provided.

FIG. 5 is a diagram illustrating an operation process of a binaural system according to another exemplary embodiment of the present invention. Referring to FIG. 5, a binaural system according to another exemplary embodiment of the present invention includes a control unit 501, a relay filter 502 and a plurality of static filters, 503, 504 and 505, which are connected to each other in parallel. The number of static filters (n) may vary according to a binaural system environment. In addition, each static filter may include a binaural synthesizer 303 and a crosstalk canceller 304 as shown in FIG. 3.

When an audio signal is inputted, the control unit 501 inputs the audio signal to the relay filter 502. The relay filter 502 inputs the audio signal to the plurality of static filters, 503, 504 and 505, in a predetermined time interval, and each of the plurality of static filters respectively creates a sound image, each in a different location, by controlling an output location of the inputted audio signal.

In an exemplary embodiment, the relay filter 502 inputs an audio signal to the static filter SF(1) 503 and inputs the audio signal to the static filter SF(2)504 after a time interval of t1. Similarly, an audio signal may be inputted to the static filter SF(3) 505 after a time interval of t2. The time interval may be determined depending upon a user's circumstances and may be irregular.

Also, since the locations of the created sound images corresponding to the plurality of static filters may be determined by a binaural synthesizer 303, sound images corresponding to a plurality of static filters may be arranged in parallel and adjusted by changing a setting of the binaural synthesizer 303.

Accordingly, each of the plurality of static filters creates a sound image in a different location, and as time passes, each sound image may be respectively created in a different location.

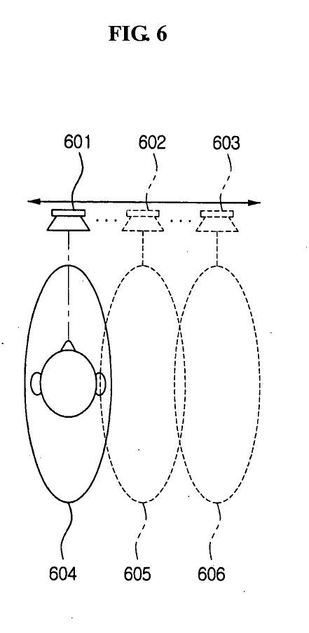

FIG. 6 is a diagram illustrating a plurality of sound images created from a binaural system according to another exemplary embodiment of the present invention. Referring to FIG. 6, the binaural system, according to another exemplary embodiment of the present invention, outputs sound images 601, 602, and 603 at different times and in different locations.

Accordingly, 604, 605, and 606 of listening sweets spots corresponding to the sound images 601, 602 and 603 may be created at different times and at different locations. Therefore, a listening sweet spot may be expanded according to a movement.

Accordingly, as a binaural system of the present invention expands a listening sweet spot by moving the sound images at a predetermined time interval, the binaural system of the present exemplary embodiment may stably provide a user with a stereo sound, even if the user moves at random within an area of a listening sweet spot.

Also, a binaural system of the present exemplary embodiment may expand a listening sweet spot without simultaneous operation of a plurality of static filters. Therefore, a load on the system for the operation of the static filters may be reduced.

On the other hand, a static filter may be embodied in the form of a software, in the case of using a number of static filters, a high performance system may be required since a size of a system memory storing a static filter of the system may become large. Thus, in order to further improve a binaural system, a modulation filter may be used in another exemplary embodiment of the present invention.

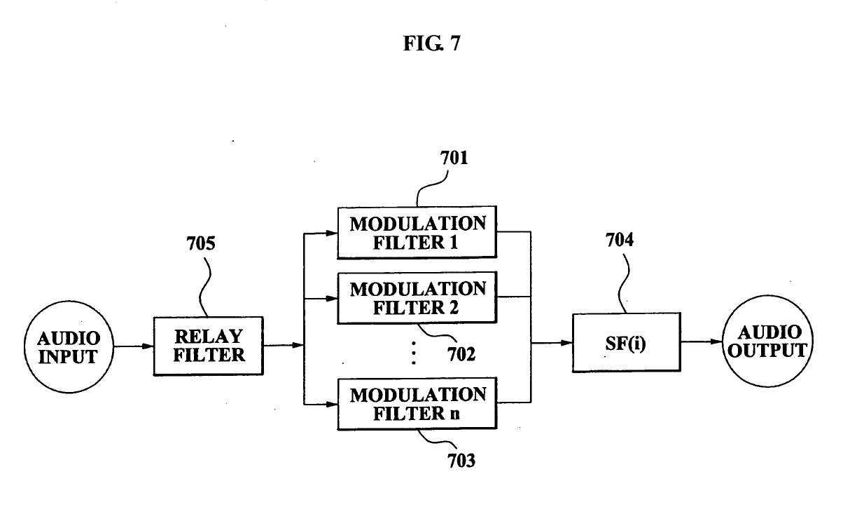

FIG. 7 is a diagram illustrating an operation process of a binaural system according to another exemplary embodiment of the present invention. Referring to FIG. 7, the binaural system according to another exemplary embodiment of the present invention includes a plurality of modulation filters 701, 702 and 703, connected in parallel, and a static filter 704. The number of modulation filters (n) may vary according to a binaural system environment. The static filter (i) may also change according to a binaural system environment. In addition, the static filter (i) may include a binaural synthesizer 303 and a crosstalk canceller 304 as shown in FIG. 3.

A control unit similar to the control unit of FIG. 5, inputs an audio signal to modulation filters 701, 702, and 703, passing through a relay filter. The modulation filter 1 701 distinguishes an inputted audio signal at each frequency domain and creates a first audio signal at a different location by controlling a phase and a gain of an audio signal, corresponding to the each frequency domain. A first audio signal is processed in a static filter and a phase and a gain are controlled in order to create a sound image at a predetermined location. In this instance, a relay filter 705 of FIG. 7 inputs an audio signal, passed via a control unit similar to 501 of FIG. 5, to the modulation filter, in order.

The modulation filters 701, 702, and 703, transmit the created first audio signal to the static filter 704 and the static filter 704 outputs the first audio signal. In this exemplary embodiment, each modulation filter creates a first audio signal that creates each sound image at different locations. Therefore, each of the sound images is created at a different location when the first audio signal is outputted from the static filter 704.

Also, according to an exemplary embodiment, each modulation filter may create a first audio signal, each first audio signal creating a sound image, each sound image created at a different time and a different location by controlling a phase and a gain of the first audio signal. Therefore, when each first audio signal is outputted from the static filter 704, a plurality of sound images are respectively created, each at a different time and at a different location.

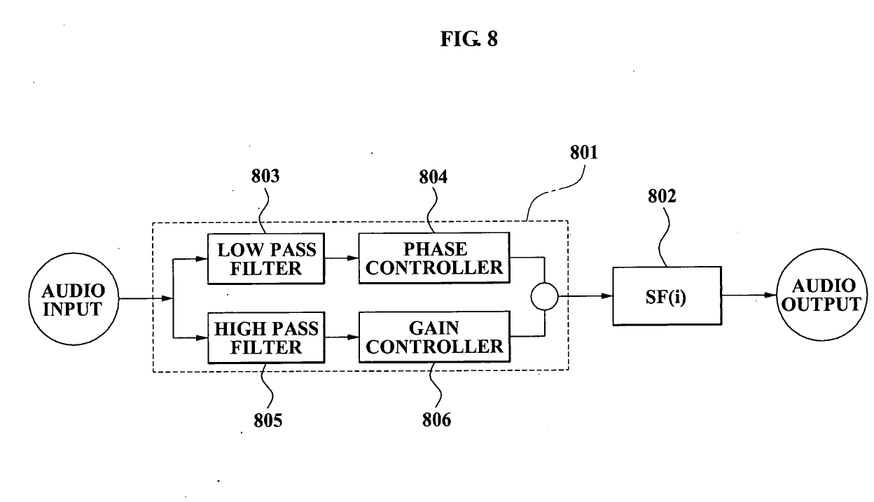

FIG. 8 is a diagram illustrating a modulation filter according to an exemplary embodiment of the present invention. Referring to FIG. 8, a modulation filter 801 creates a first audio signal that creates a sound image in a different location by controlling a dominant signal at each frequency domain.

As an example, a low pass filter 803 is adopted for a dominant signal of a low frequency domain and a phase is controlled by a phase controller 804. A high pass filter 805 is adopted for a dominant signal of a high frequency domain and a gain is controlled by the gain controller 806. After a first audio signal is created, the first audio signal is inputted to the static filter 802.

An extent of control of a phase and a gain at the modulation filters may vary according to a location of a sound image which is created by a first audio sound that is created by a modulation filter.

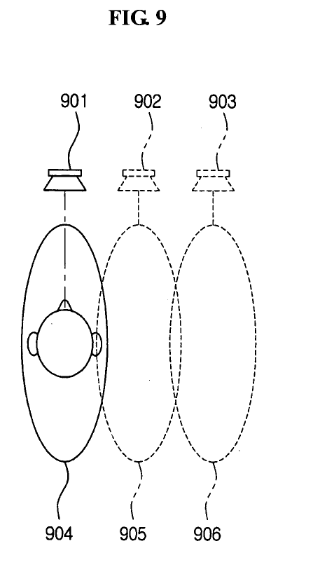

FIG. 9 is a diagram illustrating a plurality of sound images which is created from a binaural system according to another exemplary embodiment of the present invention.

As an example, an exemplary embodiment of the binaural system of the present invention creates (1) a sound image 901 by outputting a first audio signal, created from a modulation filter 701 and a static filter 704, (2) a sound image 902 by outputting a first audio signal, created from a modulation filter 702 and a static filter 704, and (3) a sound image 903 by outputting a first audio signal, created from a modulation filter 703 and a static filter 704.

A listening sweet spot corresponding to each sound image is created from 904 to 906. Thus, the present invention may expand a listening sweet spot without using a plurality of static filters.

In an exemplary embodiment of the present invention, a binaural system may respectively create each of a plurality of sound images at different times due to the fact that a binaural system may control a time when a plurality of sound images are created in each modulation filter, by controlling a phase of a first audio signal.

Accordingly, the present invention may provide a stable and an expanded listening sweet spot without using a plurality of static filters.

The described hardware devices may be configured to act as one or more software modules in order to perform the operations of the above-described exemplary embodiments of the present invention, and vice versa.

A method for a binaural system which stably provides a stereo sound, and creates a listening sweet spot corresponding to a plurality of sound images even when a user moves at random within a certain area of a listening sweet spot according to the present invention may be embodied as computer readable codes on a computer-readable recording media.

Accordingly, in addition to the above-described exemplary embodiments, exemplary embodiments of the present invention can also be implemented by executing computer readable code/instructions in/on a medium, e.g., a computer readable medium. The medium can correspond to any medium/media permitting the storing and/or transmission of the computer readable code.

The computer readable code/instructions can be recorded/transferred in/on a medium in a variety of ways, with examples of the medium including magnetic storage media (e.g., floppy disks, hard disks, magnetic tapes, etc.), optical recording media (e.g., CD-ROMs, or DVDs), magneto-optical media (e.g., floptical disks), hardware storage devices (e.g., read only memory media, random access memory media, flash memories, etc.) and storage/transmission media such as carrier waves transmitting signals, which may include instructions, data structures, etc. Examples of storage/transmission media may include wired and/or wireless transmission (such as transmission through the Internet). Examples of wired storage/transmission media may include optical wires and metallic wires. The medium/media may also be a distributed network, so that the computer readable code/instructions is stored/transferred and executed in a distributed fashion. The computer readable code/instructions may be executed by one or more processors.

The present invention may stably provide a stereo sound by creating a listening sweet spot, corresponding to a plurality of sound images, even if a user moves at random within an area of a plurality of listening sweet spots.

Also, the present invention may stably provide a stereo sound by moving a sound image in a predetermined time interval and expanding a listening sweet spot, even if a user moves at random within an area of a plurality of listening sweet spots.

Also, the present invention may reduce a load on a system since a listening sweet spot may be expanded without a simultaneous operation of a plurality of static filters.

Also, the present invention may expand a listening sweet spot by using a plurality of modulation filters without having a plurality of static filters.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A binaural system to provide a stereo sound, the binaural system comprising:
a plurality of static filters connected in parallel to each other, each of the plurality of static filters creating a sound image in a different location by controlling an output location of an audio signal; and
a control unit inputting the audio signal to each of the plurality of static filters.

2. The binaural system of claim 1, further comprising:
a relay filter receiving the audio signal from the control unit and respectively inputting the audio signal to each of the plurality of static filters at a predetermined time interval.

3. The binaural system of claim 1, wherein a plurality of sound images, created by each of the plurality of static filters, is spaced apart by a predetermined distance.

4. A binaural system to provide a stereo sound, the binaural system comprising:
a plurality of modulation filters creating a first audio signal that creates each sound image in a different location by controlling a phase and a gain of an inputted audio signal; and
a static filter creating each sound image by outputting the first audio signal.

5. The binaural system of claim 4, wherein the plurality of modulation filters creates the first audio signal that creates the each sound image in a predetermined time by controlling the phase and the gain in each frequency domain of the inputted audio signal.

6. A method of providing a stereo sound, the method comprising:
maintaining a plurality of static filters connected in parallel to each other;
inputting an audio signal to the plurality of static filters; and
respectively creating a sound image in a different location by controlling an output location of the inputted audio signal from the plurality of static filters.

7. The method of claim 6, further comprising:
inputting the inputted audio signal to the plurality of static filters in a predetermined time interval.

8. A method of providing a stereo sound, the method comprising:
creating a plurality of first audio signals, each of the plurality of first audio signals respectively creating a sound image at a different location by controlling a phase and a gain of an inputted audio signal; and
creating each of the sound image by outputting the plurality of first audio signals.

9. The method of claim 8, wherein the creating a plurality of first audio signals creates the first audio signal, respectively creating each sound image in a different location by controlling the phase and the gain of the inputted audio signal for each frequency domain.

10. A computer readable storage medium comprising computer readable instructions for executing the method of claim 6.

11. A computer readable storage medium comprising computer readable instructions for executing the method as claimed in claim 7.

12. A computer readable storage medium comprising computer readable instructions for executing the method as claimed in claim 8.

13. A computer readable storage medium comprising computer readable instructions for executing the method of claim 9.

14. The binaural system of claim 1, wherein the control unit inputs the audio signal to each of the plurality of static filters simultaneously.

15. The binaural system of claim 1, wherein the control unit does not input the audio signal to each of the plurality of static filters simultaneously.

16. The binaural system of claim 1, wherein each static filter comprises a synthesizer and a crosstalk canceller.

17. The binaural system of claim 3, wherein each of the plurality of static filters creates sound image at different times in different locations by controlling the output location of the audio signal.

18. The method of claim 7, wherein creating the sound image comprises creating the sound image at different times in different locations by controlling the output location of the inputted audio signal from the plurality of static filters.

19. A computer readable storage medium comprising computer readable instructions for executing the method of claim 18.

20. The binaural system of claim 4, further comprising:
a control unit; and
a relay filter receiving the audio signal from the control unit and inputting the audio signal to the plurality of modulation filters.

21. The binaural system of claim 4, wherein the modulation filters are in parallel.

22. A binaural system comprising:
a plurality of modulation filters receiving an inputted audio signal, wherein each modulation filter creates a modulated and filtered audio signal, each modulated and filtered audio signal is used to create a sound image in a different location by controlling a phase and a gain of the inputted audio signal; and
a control unit inputting the audio signal to each of the plurality of modulation filters.

23. The binaural system of claim 22, further comprising a static filter coupled to the plurality of modulation filters and creating each sound image based on each modulated and filtered audio signal.

24. The binaural system of claim 22, wherein the plurality of modulation filters creates each modulated and filtered audio signal that creates the each sound image in a predetermined time by controlling the phase and the gain in each frequency domain of the inputted audio signal.

25. The binaural system of claim 22, wherein the modulation filters are in parallel.

26. The binaural system of claim 22, further comprising a relay filter receiving the inputted audio signal from the control unit and inputting the audio signal to the plurality of modulation filters.
